(19) United States
(12) Patent Application Publication
(10) Pub. No.: US 2021/0032780 A1
(43) Pub. Date: Feb. 4, 2021

(54) HOLLOW FIBER

(71) Applicant: ASAHI KASEI KABUSHIKI KAISHA, Tokyo (JP)

(72) Inventors: Yoshiyuki TAZUKE, Tokyo (JP); Tatsuo TANAKA, Tokyo (JP)

(73) Assignee: ASAHI KASEI KABUSHIKI KAISHA, Tokyo (JP)

(21) Appl. No.: 16/941,531

(22) Filed: Jul. 29, 2020

(30) Foreign Application Priority Data
Jul. 31, 2019 (JP) 2019-141380

(51) Int. Cl. D01F 6/10; C08L 27/08; D01D 5/24

(52) U.S. Cl. CPC D01F 6/10; C08L 27/08; D01D 5/24; C08L 2203/12; C08L 2205/025; D10B 2321/041; D10B 2401/06; D10B 2505/04; D10B 2505/202; D10B 2503/00; C08L 2205/03

(57) ABSTRACT

The present disclosure is directed to provide a hollow fiber which is lightweight and has a texture with good volumic feel and good cushioning property. The hollow fiber of the present disclosure is a hollow fiber composed of a composition containing a vinylidene chloride-based resin as a main component, wherein the hollow fiber has a hollow ratio of more than 30% and 70% or less, an average outer diameter of 50 to 900 μm, a strength of 0.7 to 2 g/d, and a heat shrinkage rate after being heated at 100° C. for 15 minutes of 30% or less.

### CROSS-REFERENCE OF RELATED APPLICATION

This application claims priority to Japanese Patent Application No. 2019-141380, filed Jul. 31, 2019, the entire disclosure of which is incorporated herein by reference.

### TECHNICAL FIELD

The present disclosure relates to a hollow fiber.

### BACKGROUND

Vinylidene chloride resins are resins excellent in various properties, such as flame retardance, chemical resistance, gas barrier property, and are widely used as raw materials for films and sheets. Applications of vinylidene chloride resins as raw materials, however, have been limited to processed products with certain shapes because the melting temperatures of such resins are close to their decomposition temperatures, which makes processing the resins difficult.

As an exemplary processing of a vinylidene chloride resin, hollow fibers for artificial hairs made of a vinylidene chloride-based resin are known (PTL 1), for example.

### CITATION LIST

### Patent Literature

PTL 1: JP2007321250A

### SUMMARY

Recently, applications of hollow fibers made of a vinylidene chloride resin to a wide variety of fields, such as artificial turfs, have been studied because vinylidene chloride resins are excellent in elasticity and water resistance. The fibers of PTL 1 are hollow fibers suitable for artificial hairs. For applications to fields other than artificial hairs, there has been a demand for hollow fibers which are lightweight and have textures with excellent volumic feel and cushioning property.

Accordingly, the present disclosure is directed to provide a hollow fiber which is lightweight and has a texture with good volumic feel and good cushioning property.

Specifically, the present disclosure provides the following.

[1] A hollow fiber,

the hollow fiber being composed of a composition containing a vinylidene chloride-based resin as a main component, and

the hollow fiber having:
a hollow ratio of more than 30% and 70% or less;
an average outer diameter of 50 to 900 μm;
a strength of 0.7 to 2 g/d; and
a heat shrinkage rate after being heated at 100° C. for 15 minutes of 30% or less.
   [2] The hollow fiber according to [1], wherein a mass ratio of the vinylidene chloride-based resin relative to 100% by mass of the composition is 80% by mass or more.

Because the hollow fiber of the present disclosure has the above-described properties, it is lightweight and has a texture with good volumic feel and good cushioning property.

### BRIEF DESCRIPTION OF THE DRAWINGS

In the accompanying drawings:

FIG. 1 is a schematic view illustrating an example of a discharging aperture of a spinneret used for production of a hollow fiber of the present embodiment;

FIGS. 2A and 2B are photographs (cross-sectional photographs) of hollow fibers in Examples 1 and 2, wherein FIG. 2A depicts a hollow fiber with a fineness of 250 denier, and FIG. 2B depicts a hollow fiber with a fineness of 500 denier;

FIGS. 3A and 3B are photographs (cross-sectional photographs) of hollow fibers in Examples 3 and 4, wherein FIG. 3A depicts a hollow fiber with a fineness of 250 denier, and FIG. 3B depicts a hollow fiber with a fineness of 500 denier;

FIGS. 4A and 4B are photographs (cross-sectional photographs) of fibers that could not be made hollow in Comparative Examples 1 and 2, wherein FIG. 4A depicts a fiber having a fineness of 250 denier, and FIG. 4B depicts a fiber having a fineness of 500 denier;

FIGS. 5A and 5B illustrates photographs (cross-sectional photographs) of fibers that could not be made hollow in Comparative Examples 3 and 4, wherein FIG. 5A depicts a fiber having a fineness of 250 denier, and FIG. 5B depicts a fiber having a fineness of 500 denier;

FIG. 6 is a photograph (cross-sectional photograph) of a hollow fiber having a fineness of 200 denier in Comparative Example 3;

FIG. 7 is a photograph (cross-sectional photograph) of a hollow fiber in Example 5 with a fineness of 500 denier;

FIG. 8 is a photograph (cross-sectional photograph) of a hollow fiber in Example 6 with a fineness of 500 denier; and

FIG. 9 is a photograph (cross-sectional photograph) of a hollow fiber in Example 7 with a fineness of 285 denier.

### DETAILED DESCRIPTION

The following provides a detailed description of an embodiment of the present disclosure (hereinafter, referred to as the “present embodiment”). The present disclosure is not limited to the following embodiment, but may be performed by varying within the scope of the subject thereof.

Hollow Fiber

A hollow fiber of the present embodiment is a hollow fiber composed of a composition containing a vinylidene chloride-based resin as the main component, wherein the hollow fiber has a hollow ratio of more than 30% and 70% or less, an average outer diameter of 50 to 900 μm, a strength of 0.7 to 2 g/d, and a heat shrinkage rate after being heated at 100° C. for 15 minutes of 30% or less.

Fibers composed of a composition containing a vinylidene chloride-based resin as the main component are softer than fiber composed of other resins, which makes processing of such fibers difficult. Particularly, fibers which have large hollow ratios, are thicker, and have high strengths and low heat shrinkage rates are difficult to be produced.

The hollow fiber, which has a large hollow ratio, is thick, and has a high strength and a low heat shrinkage rate, of the present disclosure composed of a composition containing a vinylidene chloride-based resin as the main component, can be effectively produced by adjusting components contained in the composition, the shape (e.g., an accumulating portion width and a channel width, which will be described later) of a spinneret used for spinning, the time duration until a fiber discharged from the spinneret is immersed into a cold water bath, the melt viscosity of the composition, and other conditions.

(Composition)

The composition contains a vinylidene chloride-based resin as the main component. The composition may further contain other components.

Note that the term “composition containing a vinylidene chloride-based resin as the main component” refers to a composition containing more than 80% by mass, preferably a composition containing 85% by mass or more, and more preferably a composition containing 90% by mass or more of a vinylidene chloride-based resin, relative to 100% by mass of the total amount of the composition. When the vinylidene chloride-based resin is contained in the amount of more than 80% by mass, provision of a strength and an appearance required for products such as an artificial turf can be achieved, and production of an artificial turf which is less likely to become sticky on its surface and has a soft texture and good recoverability, is made easier.

—Vinylidene Chloride-Based Resin—

Examples of the vinylidene chloride-based resin as described above include homopolymers composed only of constituent units derived from vinylidene chloride, and copolymers comprising constituent units derived from vinylidene chloride and constituent units derived from another monomer. They may be used alone or in combination of two or more.

As the other monomer described above, any of monomers copolymerizable with vinylidene chloride can be used, and ethylene derivative monomers copolymerizable with vinylidene chloride are preferred for improving the physical properties of fibers.

Examples of such ethylene derivative monomers include (meth)acrylonitrile, (meth)acrylic acid esters such as methyl (meth)acrylate, hydroxypropyl (meth)acrylate, hydroxyethyl (meth)acrylate, and hydroxybutyl (meth)acrylate, (meth)acrylic acid, acrylamide, vinyl acetate, allyl alcohol, and vinyl chloride. Of these, methyl acrylate and vinyl chloride are preferred, and vinyl chloride is more preferred in view of the thermal stability.

These monomers may be used alone or in a combination of two or more.

When vinyl chloride is used as the other monomer, the mass ratio of constituent units derived from vinylidene chloride and constituent units derived from vinyl chloride (mass ratio of vinylidene chloride/vinyl chloride) in the copolymer is preferably 65/35 or more and 98/2 or less, more preferably 80/20 or more and 95/5 or less. When the mass ratio of constituent units derived from vinyl chloride is 35% by mass or less, the vinylidene chloride-based resin will have an excellent transparency. When this mass ratio is 2% by mass or more, the melt viscosity of the vinylidene chloride-based resin will remain low, which makes the composition to be readily melt-extruded.

Alternatively, when methyl acrylate is used as the other monomer, the mass ratio of constituent units derived from vinylidene chloride and constituent units derived from methyl acrylate (mass ratio of vinylidene chloride/methyl acrylate) in the above-mentioned copolymer is preferably 80/20 or more and 99/1 or less.

The weight-average molecular weight of the vinylidene chloride-based resin is preferably 50,000 to 80,000, more preferably 55,000 to 75,000, and even more preferably 60,000 to 70,000, because of the following: fibers excellent in strength can be produced, thermal decomposition of the resin becomes less likely to occur in an extruder, and clogging during discharge from a spinneret becomes is likely to occur during spinning, which enables continuous production of fibers without requiring exchange of spinnerets, thereby improving the productivity.

The weight-average molecular weight can be set to one of the above-mentioned ranges by using a polymerization initiator in an amount greater than amounts that have been conventionally used, or setting the polymerization temperature to be higher than temperatures that have been conventionally used, combination of these, or the like, for example.

The ratio of low molecular weight components having molecular weights of 10,000 or less in the vinylidene chloride-based resin to the total amount of the vinylidene chloride-based resin is preferably 3 to 10%, more preferably 3 to 9%, even more preferably 4 to 8%, and particularly preferably 5 to 7%, for example.

The ratio of the low molecular weight components having molecular weights of 10,000 or less can be set to one of the above-mentioned ranges by increasing the polymerization ratio of the resin, using a polymerization initiator in an amount greater than amounts that have been conventionally used, or the like, for example.

The molecular weight distribution (Mw/Mn) of the vinylidene chloride-based resin is preferably 2.0 to 5.0, more preferably 2.1 to 4.0, and even more preferably 2.2 to 3.0.

Note that the weight-average molecular weight, the molecular weight distribution, and the ratio of low molecular weight components having molecular weights of 10,000 or less can be measured by gel permeation chromatography which will be described later. The ratio of low molecular weight components having molecular weights of 10,000 or less is defined as a ratio of areas occupied by low molecular weight components having molecular weights of 10,000 or less to the total area of peaks in an obtained GPC chart.

### —GPC—

GPC measurements are carried out using a liquid chromatography apparatus (available from Shimadzu Corporation under the model name of LC-10AD), two columns (available from Showa Denko K.K. under the product name of Shodex Asahipak GS-310 7E) connected in series, and tetrohydrofuran as a carrier, with reference to polystyrene reference samples (available from GL Sciences Inc.) as external standards, at a measurement temperature of 40° C.

The vinylidene chloride-based resin may be produced by charging monomers as mentioned above into a reaction chamber equipped with a stirring blade, and polymerizing the monomers under a certain polymerization condition under stirring.

### —Other Components—

Examples of the other components as described above include a resin other than vinylidene chloride-based resins, a plasticizer, a thermal stabilizer, a surfactant, a lubricant, an antistatic agent, an antioxidant, a light stabilizer, and a pigment.

Examples of the resins other than vinylidene chloride-based resins include a vinyl chloride resin and (meth)alkyl acrylate resins.

Examples of the plasticizer include diisobutyl adipate, dibutyl adipate, acetyltributyl citrate, dibutyl sebatate, dioctyl adipate, and dioctyl phthalate. Of these, diisobutyl adipate, dibutyl adipate, and acetyltributyl citrate are preferred, and acetyltributyl citrate is more preferred, for improvement of the touch feeling of fibers to be produced.

The content of the plasticizer is preferably 12% by mass or less, more preferably 10% by mass or less, and even more preferably 8% by mass or less, relative to 100% by mass of the composition for the following: processability upon melt extrusion is improved thereby further improving the productivity of fibers; the fluidity is improved to promote mixing of weld portions, and mixing of interfaces prevents splitting of fibers; the flexibility and the recoverability of fibers are improved; and any residual plasticizer is prevented from being transferred to surfaces of fibers, thereby preventing the surfaces of the fibers from being sticky. Further, the content of the plasticizer is preferably 1% by mass or more, more preferably 3% by mass or more, and even more preferably 5% by mass or more.

Examples of the thermal stabilizer include epoxidized linseed oil, epoxidized soybean oil, bisphenol A diglycidyl ether, pentaerythrityl-tetrakis [3-(3,5-di-t-butyl-4-hydroxyphenyl) propionate], epoxidized butyl stearate, epoxidized octyl stearate, magnesium oxide, magnesium hydroxide, and paraffin. Of these, epoxidated stabilizers are preferred, and epoxidized soybean oil is more preferred.

The content of the thermal stabilizer is preferably 5% by mass or less, more preferably 4% by mass or less, and even more preferably 1 to 3% by mass, relative to 100% by mass of the composition for the following: thermal decomposition of the vinylidene chloride-based resin is reduced, and any residual plasticizer is prevented from being transferred to surfaces of fibers, thereby preventing the surfaces of the fibers from being sticky.

The sum of the contents of the plasticizer and the thermal stabilizer is preferably 17% by mass or less and more preferably 14% by mass or less, relative to 100% by mass of the composition, for preventing the surfaces of the fibers from being sticky.

(Characteristics of Hollow Fiber)

The hollow ratio of the hollow fiber of the present embodiment is more than 30% and 70% or less, preferably more than 30% and 60% or less, and more preferably 40 to 60%. When the hollow ratio is more than 30%, the fiber is lightweight and has a texture with good volumic feel and good cushioning property. When the hollow ratio is 70% or less, splitting of the fiber during spinning is reduced, and a strength sufficient to prevent fiber snapping when being processed is achieved.

The hollow ratio can be set to one of the above-mentioned ranges by adjusting the shape of a spinneret (e.g., setting the ratio of the accumulating portion width/the channel width, which will be described later, to a suitable range), the distance from where fibers are discharged from a spinneret to where the fibers are immersed into a cold water bath, the melt viscosity of the composition, the temperature of the resins, and the like, for example.

As used therein, the “hollow ratio” refers to a ratio of a cross-sectional area of a hollow portion of a fiber to a cross-sectional area defined by the outer diameter of the fiber, when a cross section orthogonal to the longitudinal direction of the fiber is observed under a microscope. The hollow ratio of a hollow fiber may be determined by determining hollow ratios in five cross sections of the hollow fiber and averaging the five determined hollow ratios. Note that, as used herein, the “longitudinal direction of a hollow fiber” may be a direction along which the fiber is ejected from a spinneret.

The average outer diameter of the hollow fiber of the present embodiment is 50 to 900 μm, preferably 100 to 700 μm, and more preferably 150 to 350 μm in view of the volumic feel and the cushioning property.

The average outer diameter can be set to one of the above-mentioned ranges by adjusting the shape of a spinneret (e.g., setting the ratio of the accumulating portion width/the channel width, which will be described later, to a suitable range), the amount of a resin to be discharged from the spinneret, the stretching ratio, the melt viscosity of the composition, and the like, for example.

As used therein, the “outer diameter” refers to the outer diameter of an assumed perfect circle that is determined from the actual shape of the fiber in a cross section perpendicular to the longitudinal direction of the fiber when the cross section is observed under Microscope VHX-6000 available from Keyence Corporation, and an assumption is made that the cross-sectional shape of the fiber is the perfect circle. The average outer diameter of a hollow fiber may be determined by measuring outer diameters in five cross sections of the hollow fiber and averaging the five measured outer diameters.

The strength of the hollow fiber of the present embodiment is 0.7 to 2.0 g/d, preferably 0.9 to 1.7 g/d, and more preferably 1.0 to 1.5 g/d, in view of achieving a strength sufficient to prevent fiber snapping during fiber twisting or tufting (process to place hollow fibers into a base fabric such as a vinyl chloride resin sheet) during a process in which fibers are processed into an artificial turf or the like.

The strength can be set to one of the above-mentioned ranges by adjusting the components contained in the composition, the hollow ratio, the stretching ratio, the stretching temperature, and the like.

As used therein, the “strength” refers to a value measured by the method that will be described in EXAMPLES described later.

The heat shrinkage rate after the hollow fiber of the present embodiment is heated at 100° C. for 15 minutes is 30% or less in view of the volumic feel and the cushioning property, and is preferably 20% or less, more preferably 15% or less, and even more preferably 10% or less, in view of retention of the shape and functionalities in cases where thermal processing is carried out.

The heat shrinkage rate can be set to one of the above-mentioned ranges by adjusting the components contained in the composition, the hollow ratio, the stretching ratio, the stretching temperature, and the like.

As used therein, the “heat shrinkage rate” refers to a ratio of a difference between a length of a hollow fiber before the heating and a length of a hollow fiber after it is heated at 100° C. for 15 minutes to the length of the hollow fiber before the heating.

The cross-sectional shape of the hollow fiber of the present embodiment is not particularly limited, and exemplary shapes include circular, elliptical, and polygonal shapes. The cross-sectional shape may vary or may be the same along the longitudinal direction of the fiber.

Preferably, the hollow fiber of the present embodiment has a single hole that extends in the longitudinal direction from one fiber end to the other fiber end, and does not have any holes extending from an inside of the hollow to an outside of the fiber except for the fiber ends.

(Method of Producing Hollow Fiber)

The hollow fiber of the present embodiment can be produced, for example, by using a method in which the composition described above is supplied to an extruder, melt-extruded to be discharged from a spinneret, cooled in a cold water bath, stretched at a stretching temperature or a stretching ratio suitable to obtain a desired fiber, and wound around a bobbin. The hollow fiber may also be dried.

The spinneret is provided with a plurality of discharging apertures.

The number of the discharging apertures provided to the spinning is not particularly limited, and the number can be appropriately selected in view of the target average outer diameter of a hollow fiber and the amount to be discharged from an extruder (the flow rate of the resin from the discharging apertures), and the spinning speed.

Examples of the discharging apertures include a discharging aperture in which a plurality of slits (e.g., arc-shaped slits, straight-line slits, slits with a curved line, or the like) that are arranged so as to form a shape, such as a circle or a polygonal shape, having gaps interposed therebetween, for example.

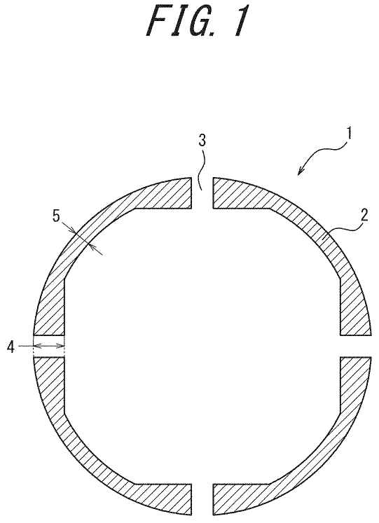

FIG. 1 illustrates a discharging aperture 1, and in this discharging aperture, four arc-shaped slits 2 are arranged in a circular shape having canals 3 (gaps) interposed therebetween. Fibers ejected from the arc-shaped slit join with fibers ejected from the adjacent slits by the Barus effect, thereby forming a hollow fiber.

In this specification, the width of the discharging aperture at the canals 3 of the discharging aperture 1 may be referred to as the “width of the accumulating portion 4”, and the width of the discharging aperture at the midpoint of two canals 3 may be referred to as the “width of the channel 5”. Preferably, the width of the discharging aperture becomes the largest at the width of the accumulating portion 4 and becomes the smallest at the width of the channel 5 (FIG. Further, a preferred shape is that the width of the discharging aperture is reduced from the canals 3 toward the midpoints of the canals (as in FIG. 1), or is constant (the shape in which the discharging aperture is not widened).

The number of the canals 3 in each discharging aperture is preferably 2 to 8, more preferably 2 to 6, and even more preferably 4. Canals in too small number are not preferable because the pressure upon a discharge of the composition is concentrated in the canals when a fiber having a high hollow ratio is attempted to be produced, which may lead to a broken canal or the like, resulting in destruction of the discharging apertures. In contrast, too many canals are not preferable because thermal aging may be caused by accumulation of the vinylidene chloride-based resin at the canal portions, which may increase the probability of fiber snapping the like, resulting in a reduced productivity.

We have found that a hollow fiber having a high hollow ratio and a desired shape could not be obtained only by making discharging apertures larger when we attempted to produce thick hollow fibers. Our intensive studies have led to the finding that a hollow fiber of the present disclosure having a high hollow ratio and a large outer diameter can be produced by modifying the shape of the discharging apertures or other conditions.

The discharging apertures preferably have a ratio of the width of the accumulating portion 4 to the width of the channel 5 (the ratio of the accumulating portion width/the channel width) of 1.00 to 1.70, more preferably 1.20 to 1.67, and even more preferably 1.30 to 1.60.

By setting the ratio of the accumulating portion width/the channel width within one of the above-mentioned ranges, a hollow fiber having a hollow ratio in a certain range (e.g., more than 30% and 70% or less) can be produced. In addition, a hollow-shaped fiber having a uniform thickness is produced.

The temperature of the resin upon melt-extruding the composition may be 160 to 200° C., and is preferably 160° C. or higher for formation of a hollow shape. In order to prevent fiber snapping caused by thermal decomposition of the vinylidene chloride-based resin, the temperature is preferably 200° C. or lower. The temperature is more preferably 170° C. to 190° C., and even more preferably 175 to 185° C. By adjusting the temperature of the spinneret and/or the temperature of the composition, the joinability of the resin ejected, the viscosity of the composition, and the like can be controlled, so that the hollow fiber of the present disclosure which has a large hollow ratio (e.g., more than 30% and not more than 70%) and a large average outer diameter (e.g., the average outer diameter of 50 to 900 μm) can be readily produced.

A fiber discharged from the spinneret is preferably cooled for retaining a hollow shape and achieving crystallinity appropriate for imparting a stretch orientation. The method for cooling is not particularly limited, and examples thereof include air cooling and water cooling. For example, fibers ejected from a plurality of slits of a discharging aperture may be cooled in the air while they are allowed to join together, and the joined hollow fiber may be further water cooled in a cold water bath.

Particularly, for allowing fibers ejected from adjacent slits to join together after being discharged, and producing a hollow-shaped fiber with a more uniform thickness, as well as for retaining the shape of a formed hollow fiber more readily, the time duration from when the resin is discharged from the spinneret to when the resin is immersed into a cold water bath (e.g., a cold water bath at a temperature of 5 to 15° C.) is preferably 1 second or shorter, more preferably 0.02 to 0.6 seconds, and even more preferably 0.2 to 0.5 seconds.

In addition, the time duration for keeping the fiber in the cold water bath may be, for example, 0.3 to 1.0 seconds.

The fiber may be stretched after it is discharged. The stretching may be carried out in the cold water bath.

The stretching temperature may be 40° C. to 60° C.

Further, the stretching ratio is preferably 2 to 5 times, more preferably 2.5 to 4.5 times for aligning the crystal orientation of the resin to thereby increase the strength of a hollow fiber, and controlling the heat shrinkage rate in the longitudinal direction to thereby set the outer diameter and the fineness of the hollow fiber within desired ranges.

The draft ratio is preferably 5 to 40 and more preferably 10 to 30, for aligning the crystal orientation of the resin to thereby increase the strength of a hollow fiber, and setting the outer diameter and the fineness of the hollow fiber within desired ranges. A hollow fiber having a greater fineness is produced as the draft ratio is reduce, whereas a hollow fiber having a smaller fineness is obtained as the draft ratio is increased.

As used therein, the “draft ratio” can be calculated from the following equation:

Draft ratio=[{the cross-sectional area (cm²) of each discharging aperture of the spinneret×the density (g/cm³) of the resin×9000 (m)}/{the fineness (denier) of a single fiber×the stretching ratio (times)}]×100

The hollow fiber of the present embodiment is lightweight and has a texture with good volumic feel and good cushioning property. Thus, it can be used for an artificial turf, a brush, a nonwoven fabric filter, and the like.

### EXAMPLES

The present disclosure will be described hereinafter based on examples, but the present disclosure is not limited to the following examples.

The conditions and results of Examples and Comparative Examples are summarized in Table 1.

### Example 1

A monomer mixture consisting of 81.5 parts by mass of vinylidene chloride, 18.5 parts by mass of vinyl chloride, and 0.5 parts by mass of diisopropyl peroxydicarbonate as a polymerization initiator was prepared, which was radically polymerized at a polymerization temperature of 60° C. to yield a vinylidene chloride-vinyl chloride copolymer resin (Resin A). The polymerization ratio was 90% and the molecular weight (Mw) was 94,000.

A mixture consisting of 85 parts by mass of vinylidene chloride, 15 parts by mass of vinyl chloride, and 0.5 parts by mass of t-butylperoxy pivalate as a polymerization initiator was prepared, which was radically polymerized at a polymerization temperature of 65° C. to yield a vinylidene chloride-vinyl chloride copolymer resin (Resin B). The polymerization ratio was 93% and the molecular weight (Mw) was 50,000.

In a V-type blender, 66.4% by mass of Resin A, 28.4% by mass of Resin B, 3.6% by mass of acetyltributyl citrate (available from MORIMURA BROS., INC. under the product name of Citroflex A-4) as a plasticizer, 1.6% by mass of epoxidized linseed oil (available from NOF CORPORATION under the product name of NEWCIZER-51) as a thermal stabilizer were mixed to yield a resin composition.

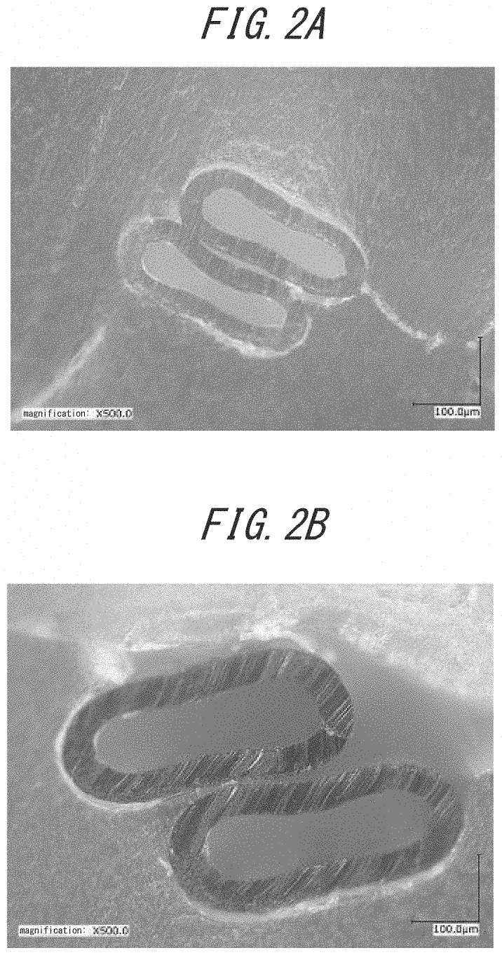

This resin composition was then charged into a single screw extruder having a screw diameter of 65 mm (in an extrusion amount of 50 kg/hr), melt-spun from a spinneret A (which had an aperture diameter of 3 mm, and a ratio of the accumulating portion width/the channel width of 1.44) at an extrusion temperature of 180° C., and rapidly cooled for 0.5 seconds in a cold water bath adjusted to 10° C. The time duration between the discharge and the immersion in the cold water bath was 0.22 seconds. Thereafter, the resin composition was made to pass through a hot water bath at 50° C., and stretched by 4 times by speed differential rollers to yield 250-denier fibers. The cross-sectional shape of the hollow is depicted in FIG. 2A. The hollow ratio of the fibers was 51.4%. The average outer diameter was 236 μm, the strength was 1.09 g/d, and the shrinkage rate after being heated at 100° C. for 15 minutes was 11.9%. An artificial turf was produced from the fibers, and the recovery rate of the artificial turf was measured to be 80% or more, which was determined to be B (good).

### Example 2

In the same manner as in Example 1, 500-denier fibers were produced except for the following changes: the time duration between the discharge and the immersion in the cold water bath was 0.44 seconds, and the cooling time in the cold water bath was 0.55 seconds.

### Example 3

In the same manner as in Example 1, 250-denier fibers were produced except for the following change: a spinneret B (which had an aperture diameter of 3 mm, and a ratio of the accumulating portion width/the channel width of 1.67) was used.

### Example 4

In the same manner as in Example 1, 500-denier fibers were produced except for the following changes: the spinneret B was used, the time duration between the discharge and the immersion in the cold water bath was 0.44 seconds, and the cooling time in the cold water bath was 0.55 seconds.

### Example 5

In a V-type blender, 93.4% by mass of Resin A, 5.3% by mass of acetyltributyl citrate (available from MORIMURA BROS., INC. under the product name of Citroflex A-4) as a plasticizer, and 1.3% by mass of epoxidized linseed oil (available from NOF CORPORATION under the product name of NEWCIZER-51) as a thermal stabilizer were mixed to yield a resin composition.

In the same manner as in Example 1, 500-denier fibers were produced except that the time duration between the discharge and the immersion in the cold water bath was 0.55 seconds, and the cooling time in the cold water bath was 0.55 seconds.

### Example 6

In a V-type blender, 63.1% by mass of Resin A, 27.1% by mass of Resin B, 8.3% by mass of acetyltributyl citrate (available from MORIMURA BROS., INC. under the product name of Citroflex A-4) as a plasticizer, and 1.5% by mass of epoxidized linseed oil (available from NOF CORPORATION under the product name of NEWCIZER-51) as a thermal stabilizer were mixed to yield a resin composition.

In the same manner as in Example 1, 500-denier fibers were produced except that the time duration between the discharge and the immersion in the cold water bath was 0.55 seconds, and the cooling time in the cold water bath was 0.55 seconds.

### Example 7

In a V-type blender, 63.1% by mass of Resin A, 27.1% by mass of Resin B, 8.3% by mass of acetyltributyl citrate (available from MORIMURA BROS., INC. under the product name of Citroflex A-4) as a plasticizer, and 1.5% by mass of epoxidized linseed oil (available from NOF CORPORATION under the product name of NEWCIZER-51) as a thermal stabilizer were mixed to yield a resin composition.

In the same manner as in Example 1, 285-denier fibers were produced except that the time duration between the discharge and the immersion in the cold water bath was 0.31 seconds, and the cooling time in the cold water bath was 0.31 seconds.

### Comparative Example 1

In the same manner as in Example 1, 250-denier fibers were produced except for the following change: a spinneret C (which had an aperture diameter of 3 mm, and a ratio of the accumulating portion width/the channel width of 1.86) was used. An observation of a cross section confirmed that no hollow shape was formed.

### Comparative Example 2

In the same manner as in Example 1, 500-denier fibers were produced except for the following changes: the spinneret C (which had a hole diameter of 3 mm, a ratio of a lump width/a channel width of 1.86) was used, the time duration between the discharge and the immersion in the cold water bath was 0.44 seconds, and the cooling time in the cold water bath was 0.55 seconds. An observation of a cross section confirmed that no hollow shape was formed.

### Comparative Example 3

In the same manner as in Example 1, 250-denier fibers were produced except for the following change: a spinneret D (which had an aperture diameter of 3 mm, and a ratio of the accumulating portion width/the channel width of 1.71) was used. An observation of a cross section confirmed that no hollow shape was formed.

### Comparative Example 4

In the same manner as in Example 1, 500-denier fibers were produced except for the following changes: the spinneret D (which had an aperture diameter of 3 mm, ratio of accumulating portion width/channel width: 1.71) was used, the time duration between the discharge and the immersion in the cold water bath was 0.44 seconds, and the cooling time in the cold water bath was 0.55 seconds. An observation of a cross section confirmed that no hollow shape was formed.

### Comparative Example 5

In the same manner as in Example 1, 200-denier fibers were produced except for the following changes: a spinneret E (which had an aperture diameter of 1.2 mm, the ratio of lump width/channel width was 1.67) was used, the time duration between the discharge and the immersion in the cold water bath was 0.05 seconds, the cooling time in the cold water bath was 0.55 seconds. An observation of a cross section confirmed a formation of a hollow shape, but the hollow ratio was 27.7%.

Evaluations

The hollow fibers or fibers produced in Examples and Comparative Examples were subjected to the following evaluations.

(Cross-Sectional Shape)

A produced hollow fiber was cut in a direction perpendicular to the longitudinal direction by a razor blade, and the cross section was observed under Microscope VHX-6000 available from Keyence Corporation, to obtain an image of the cross section.

(Hollow Ratio)

For each hollow fiber, images in five cross sections were taken. In each image, the proportion occupied by the cross-sectional area of a hollow portion of a fiber relative to the cross-sectional area defined by the outer diameter of the fiber was determined, which were averaged and taken as the hollow ratio (%).

(Average Outer Diameter)

In each of the obtained cross-sectional images, the length of the outer circumference was measured. It was assumed that the cross section was a perfect circle, and the outer diameter of the assumed perfect circle in the image is determined. Similar determinations were made on five cross sections, and the average of the five outer diameters was taken as the average outer diameter.

(Strength)

The tensile strength of a hollow fiber was measured using a tensile testing machine (Autograft AGS-J available from Shimadzu Corporation) according to the method in JIS L1013. One hollow fiber in 450 mm long was tested with a chuck distance of 300 mm and a tensile rate of 300 mm/min to measure the tensile strength upon breakage. Note that an average of measured tensile strengths of five hollow fibers was taken as the tensile strength.

(Heat Shrinkage Rate)

A hollow fiber of 1 m long was heated at 100° C. for 15 minutes. The ratio of a difference between a length of a hollow fiber before the heating and a length of a hollow fiber after it is heated at 100° C. for 15 minutes to the length of the hollow fiber before the heating (the difference/length of the hollow fiber before heating×100) was taken as the heat shrinkage rate (%).

(Recoverability)

Produced hollow fibers were subjected to crimping. The hollow fibers were then tufted with a nominal weight of 3 kg/m² and a pile length of 30 mm into a lined base fabric made of polyester having a width of 500 mm. Then, latex was applied on the back surface of the base fabric and dried so that piles did not come off, and the product was rolled to produce a rolled artificial turf.

From this rolled artificial turf, a piece in a width of 100 mm and a length of 100 mm was cut out, and heights of piles of hollow fibers from the surface of the lined base fabric were measured. The heights were averaged, which was taken as a pre-load pile height (mm). A weight of 25 kg with a width of 100 mm and a length of 100 mm was placed for 150 hours on the artificial turf whose pile height had been measured. After the weight was removed, the height of the piles of the hollow fibers was measured in the similar manner, and taken as the post-load pile height (mm). Then, after the artificial turf was left to stand for 24 hours, the height of the piles of the hollow fibers was measured in the similar manner and taken as the pile height after recovery (mm).

The recovery rate was calculated by the following formula:

Recovery rate (%)=the pile height after recovery/the pre-load pile height×100

The recovery rate was rated according to the following criteria.

A (excellent): 85% or more to 100% or less

B (good): 70% or more to less than 85%

C (poor): less than 70%

(Lightweightness)

The lightweightness was rated according to the following criteria based on the appearance of an artificial turf produced with a nominal weight of 3 kg/m².

A (excellent): Piles were very densely laid having good volumic feel

B (good): Piles were dense with fewer spaces

C (poor): In piles, spaces were visible in large number

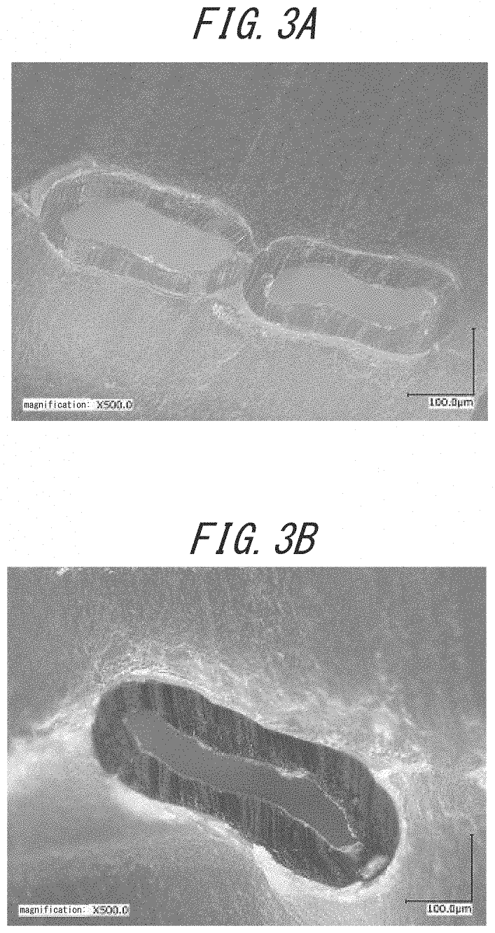

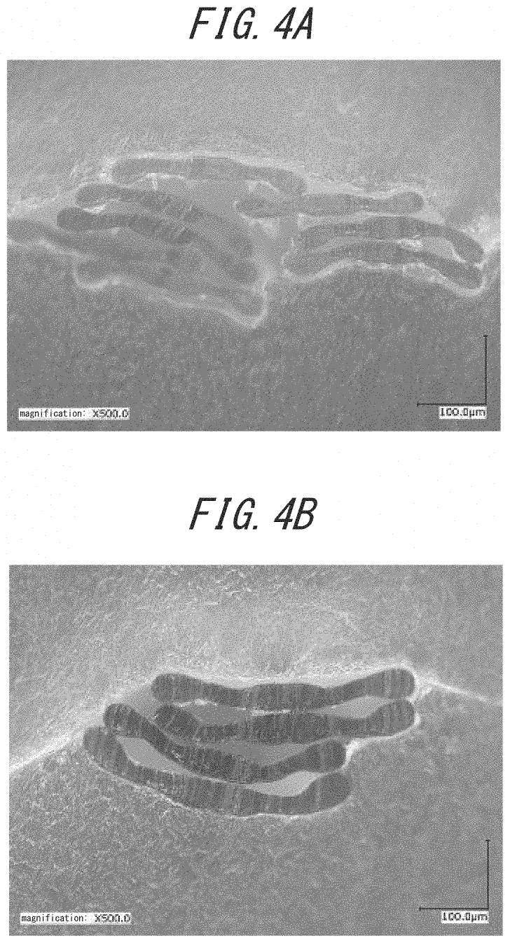

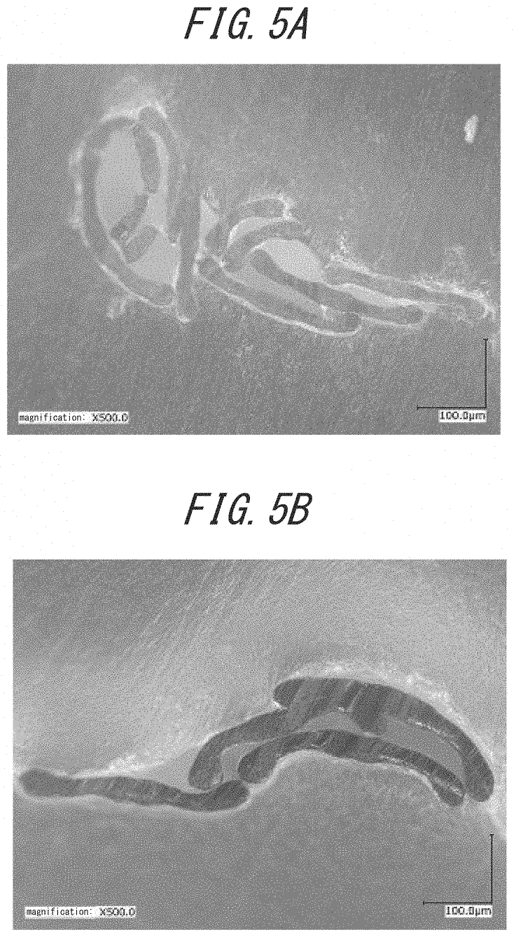

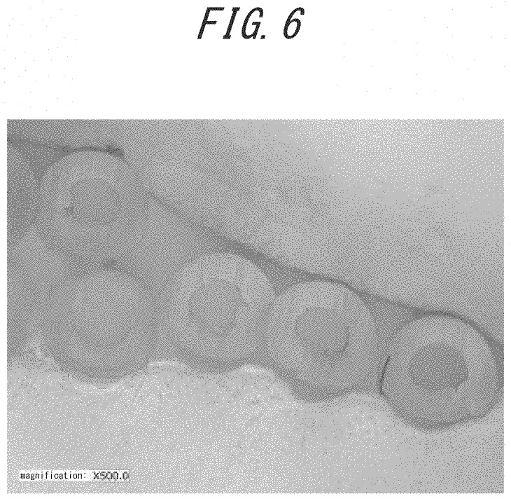

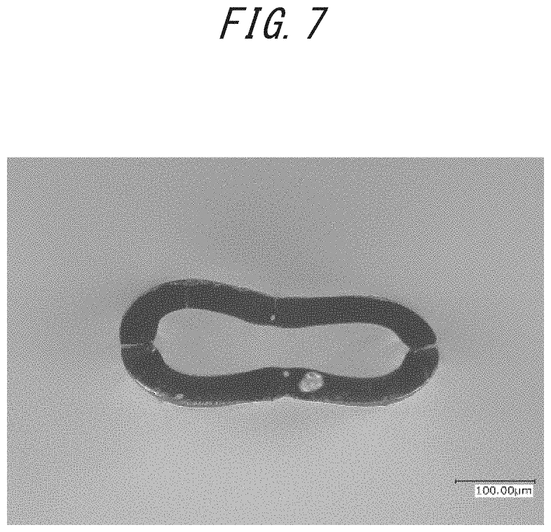

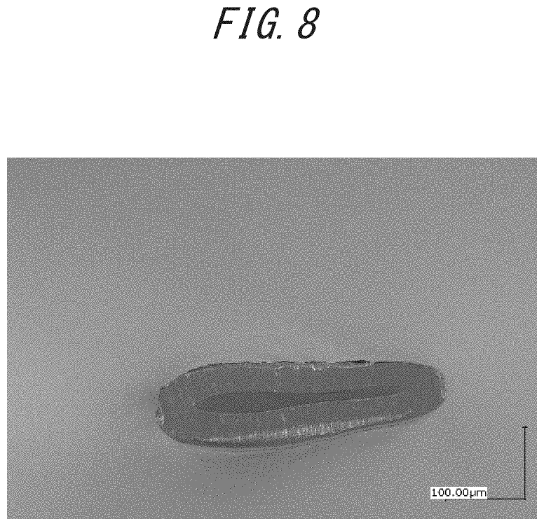

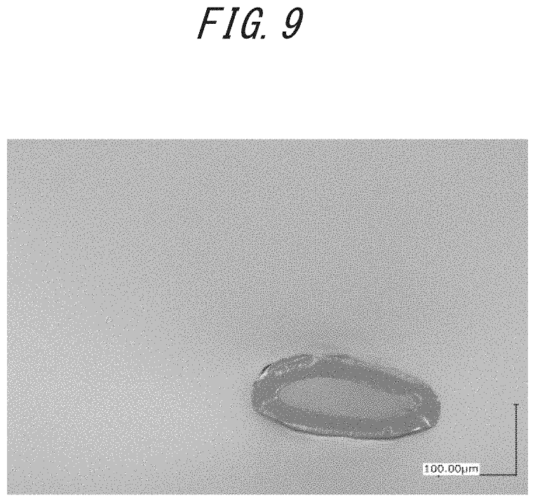

TABLE 1

| | | | | Ex. 1 | Ex. 2 | Ex. 3 | Ex. 4 | Ex. 5 | Ex. 6 | Ex. 7 |
|---|---|---|---|---|---|---|---|---|---|---|
| Resin | Resin | Resin A | mass % | 66.4 | 66.4 | 66.4 | 66.4 | 93.4 | 63.1 | 63.1 |
| composition | | Resin B | mass % | 28.4 | 28.4 | 28.4 | 28.4 | 0 | 27.1 | 27.1 |
| | Additive | Acetyltributyl citrate | mass % | 3.6 | 3.6 | 3.6 | 3.6 | 5.3 | 8.3 | 8.3 |
| | | Epoxidized linseed oil | mass % | 1.6 | 1.6 | 1.6 | 1.6 | 1.3 | 1.5 | 1.5 |

| | | | | | | | | | |
|---|---|---|---|---|---|---|---|---|---|
| Production | Spinneret type | — | A | A | B | B | A | A | A |
| method | Diameter of each | mm | 3 | 3 | 3 | 3 | 3 | 3 | 3 |
| | discharging aperture | | | | | | | | |
| | Ratio of accumulating portion | — | 1.44 | 1.44 | 1.67 | 1.67 | 1.44 | 1.44 | 1.44 |
| | width/channel width of | | | | | | | | |
| | each discharging aperture | | | | | | | | |
| | Number of canals in | — | 4 | 4 | 4 | 4 | 4 | 4 | 4 |
| | discharging aperture | | | | | | | | |
| | Time duration to immerse | sec | 0.22 | 0.44 | 0.22 | 0.44 | 0.55 | 0.55 | 0.31 |
| | discharged fibers in cold water | | | | | | | | |
| | bath | | | | | | | | |
| | Cooling time in cold water | sec | 0.27 | 0.55 | 0.27 | 0.55 | 0.55 | 0.55 | 0.31 |
| | bath | | | | | | | | |
| | Draft ratio | — | 23.9 | 11.9 | 25.8 | 12.9 | 11.9 | 11.9 | 21.0 |
| | Stretching ratio | times | 4.0 | 4.0 | 4.0 | 4.0 | 4.0 | 4.0 | 4.0 |
| Hollow fiber | Cross-sectional shape | — | FIG. 2A | FIG. 2B | FIG. 3A | FIG. 3B | FIG. 7 | FIG. 8 | FIG. 9 |
| | Fineness | denier | 250 | 500 | 250 | 500 | 500 | 500 | 285 |
| | Hollow ratio | % | 51.4 | 53.0 | 53.3 | 53.7 | 54.9 | 43.8 | 41.3 |
| | Average outer diameter | μm | 236 | 346 | 261 | 383 | 296 | 263 | 195 |
| | Strength | g/d | 1.09 | 1.00 | 1.17 | 1.15 | 1.43 | 0.96 | 1.26 |
| | Heat shrinkage rate after | % | 11.9 | 4.4 | 13.1 | 5.6 | 15.3 | 5.1 | 14.7 |
| | heated at 100° C. for 15 min | | | | | | | | |
| Evaluations | Recoverbility | — | B | B | B | B | A | A | A |
| | Lightweightness | — | A | A | A | A | A | B | B |

| | | | | Comp. | Comp. | Comp. | Comp. | Comp. |
|---|---|---|---|---|---|---|---|---|
| | | | | Ex. 1 | Ex. 2 | Ex. 3 | Ex. 4 | Ex. 5 |
| Resin | Resin | Resin A | mass % | 66.4 | 66.4 | 66.4 | 66.4 | 66.4 |
| composition | | Resin B | mass % | 28.4 | 28.4 | 28.4 | 28.4 | 28.4 |
| | Additive | Acetyltributyl citrate | mass % | 3.6 | 3.6 | 3.6 | 3.6 | 3.6 |
| | | Epoxidized linseed oil | mass % | 1.6 | 1.6 | 1.6 | 1.6 | 1.6 |

| | | | | | | | |
|---|---|---|---|---|---|---|---|
| Production | Spinneret type | — | C | C | D | D | E |
| method | Diameter of each | mm | 3 | 3 | 3 | 3 | 1.2 |
| | discharging aperture | | | | | | |
| | Ratio of accumulating portion | — | 1.86 | 1.86 | 1.71 | 1.71 | 1.67 |
| | width/channel width of | | | | | | |
| | each discharging aperture | | | | | | |
| | Number of canals in | — | 4 | 4 | 4 | 4 | 1 |
| | discharging aperture | | | | | | |
| | Time duration to immerse | sec | 0.22 | 0.44 | 0.22 | 0.44 | 0.05 |
| | discharged fibers in cold water | | | | | | |
| | bath | | | | | | |
| | Cooling time in cold water | sec | 0.27 | 0.55 | 0.27 | 0.55 | 0.55 |
| | bath | | | | | | |
| | Draft ratio | — | 21.3 | 10.6 | 20.2 | 10.1 | 8.4 |
| | Stretching ratio | times | 4.0 | 4.0 | 4.0 | 4.0 | 4.0 |
| Hollow fiber | Cross-sectional shape | — | FIG. 4A | FIG. 4B | FIG. 5A | FIG. 5B | FIG. 6 |
| | Fineness | denier | 250 | 500 | 250 | 500 | 200 |
| | Hollow ratio | % | — | — | — | — | 27.7 |
| | Average outer diameter | μm | — | — | — | — | 165 |
| | Strength | g/d | 1.13 | 1.09 | 0.97 | 1.03 | 1.10 |
| | Heat shrinkage rate after | % | 12.3 | 5.1 | 14.2 | 6.3 | 10.0 |
| | heated at 100° C. for 15 min | | | | | | |
| Evaluations | Recoverbility | — | C | C | C | C | B |
| | Lightweightness | — | C | C | C | C | C |

### REFERENCE SIGNS LIST

1 Discharging aperture
2 Arc-shaped slit
3 Canal
4 Accumulating portion width
5 Passage width

1. A hollow fiber,
the hollow fiber being composed of a composition containing a vinylidene chloride-based resin as a main component, and
the hollow fiber having:
a hollow ratio of more than 30% and 70% or less;
an average outer diameter of 50 to 900 μm;
a strength of 0.7 to 2 g/d; and
a heat shrinkage rate after being heated at 100° C. for 15 minutes of 30% or less.

2. The hollow fiber according to claim 1, wherein a mass ratio of the vinylidene chloride-based resin relative to 100% by mass of the composition is 80% by mass or more.
